(19) United States
(12) Patent Application Publication
(10) Pub. No.: US 2011/0276843 A1
(43) Pub. Date: Nov. 10, 2011

(54) INTELLIGENT ERROR-REPORTING APPARATUS AND METHOD

(75) Inventors: Louis D. Echevarria, New York, NY (US); Stefan Lehmann, Tucson, AZ (US); Benjamin Terris, Tucson, AZ (US); Richard A. Welp, Tucson, AZ (US)

(73) Assignee: INTERNATIONAL BUSINESS MACHINES CORPORATION, Armonk, NY (US)

(21) Appl. No.: 12/773,843

(22) Filed: May 5, 2010

(51) Int. Cl. G06F 11/07

(52) U.S. Cl. 714/55; 714/E11.025

(57) ABSTRACT

A method for intelligently reporting errors is disclosed herein. In one embodiment, such a method includes detecting an error and determining whether the error belongs to an error group. Such an error group may include errors that together are an indicator of a potentially more serious error or condition. The method may further determine whether all errors in the error group have occurred within a specified time period. If all errors in the error group have occurred within the specified time period, the method automatically sends a notification to an administrator or other hardware or software-based system so that the problem or error can be addressed. A corresponding apparatus and computer program product are also disclosed herein.

### FIELD OF THE INVENTION

This invention relates to apparatus and methods for intelligently reporting errors in hardware- and software-based systems.

### BACKGROUND OF THE INVENTION

Error reporting can be an important feature in many hardware- and/or software-based systems. For example, effective error reporting in operating systems and other software systems can enable programmers to quickly generate fixes that will eliminate or reduce the frequency of errors, thereby minimizing their impact. Effective error reporting can also enable system administrators to quickly address problems on computers, servers, storage systems, and other computing devices. A quick response can reduce system downtime and potentially prevent more serious problems from occurring in the future. The 80/20 rule stands for the proposition that a small set of bugs is responsible for the vast majority of problems in software-based system. In other words, fixing twenty percent of the code defects can eliminate eighty percent of the problems the software may encounter. Thus, an effective error-reporting system may be used advantageously to significantly reduce the number and frequency of errors that a hardware- and/or software-based system will encounter.

Nevertheless, many error-reporting systems are not without their drawbacks. For example, error-reporting systems may, in some cases, not provide sufficient information to correct a problem. As a result, much of a system administrator's time may be spent following blind alleys due to poorly constructed and unclear messages that contain insufficient information. Other error-reporting systems may provide the wrong type of information, such as information about an error's symptoms as opposed its root cause. Yet other error-reporting systems may bombard a system administrator with too many messages. In such cases, system administrators may spend valuable time sifting through error messages to determine which to address and which to ignore, instead of actually addressing the problem.

In view of the foregoing, what are needed are apparatus and methods to more intelligently report errors or other problems occurring in hardware- and/or software-based systems. Such apparatus and methods will ideally provide more complete information to correct problems and provide information about the root causes of errors as opposed to their symptoms. Such apparatus and methods will also ideally filter and prioritize error messages so that a system administrator can efficiently allocate time and resources.

### SUMMARY

The invention has been developed in response to the present state of the art and, in particular, in response to the problems and needs in the art that have not yet been fully solved by currently available apparatus and methods. Accordingly, the invention has been developed to provide apparatus and methods for more intelligently reporting errors in hardware- and/or software-based systems. The features and advantages of the invention will become more fully apparent from the following description and appended claims, or may be learned by practice of the invention as set forth hereinafter.

Consistent with the foregoing, a method for intelligently reporting errors is disclosed herein. In one embodiment, such a method includes detecting an error and determining whether the error belongs to an error group. Such an error group may include errors that together are an indicator of a potentially more serious error or condition. The method may further determine whether all errors in the error group have occurred within a specified time period. If all errors in the error group have occurred within the specified time period, the method automatically sends a notification to an administrator or other hardware or software-based system (e.g., a server, computer, etc.) so that the problem or error can be addressed.

A corresponding apparatus and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram of one example of a network architecture where an apparatus, method, and/or computer program product in accordance with the invention may be implemented;

FIG. 2 is a high-level block diagram showing an error-reporting module in a device, the error-reporting module communicating with one or more external devices;

FIG. 3 is a block diagram showing one embodiment of an error-reporting module in accordance with the invention;

FIG. 4 is a flow diagram showing one embodiment of a method for reporting errors; and

FIG. 5 is a flow diagram showing another embodiment of a method for reporting errors.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions or code. The computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

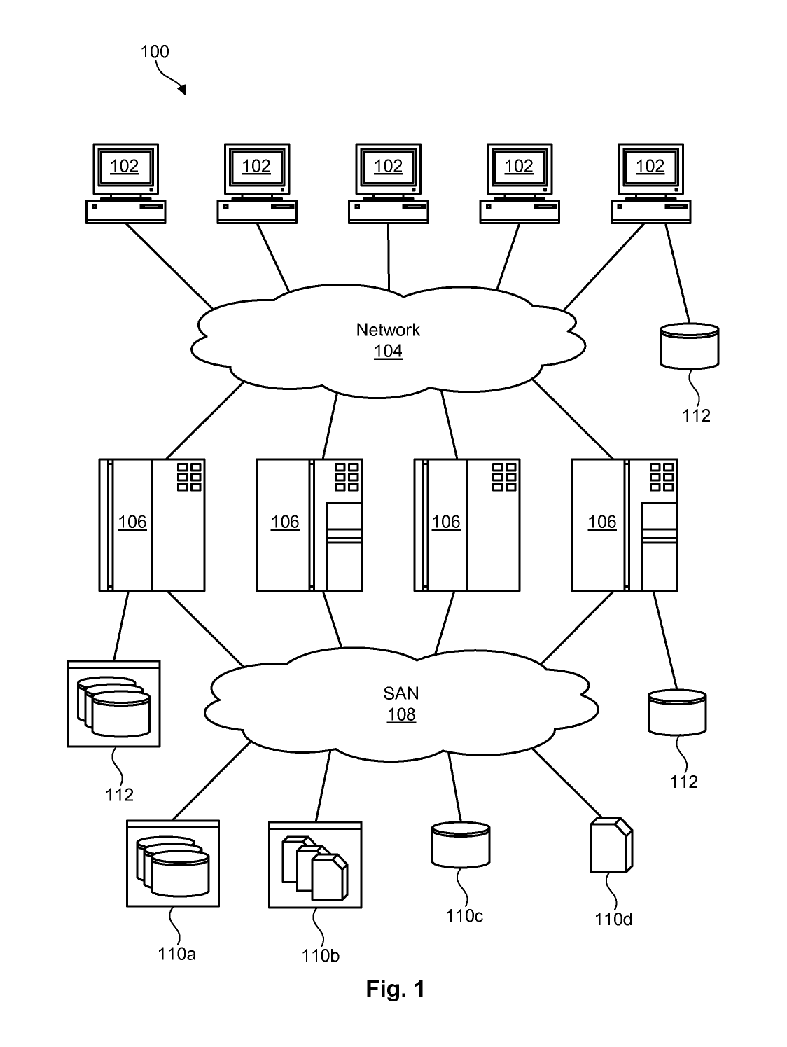

Referring to FIG. 1, one example of a network architecture 100 is illustrated. The network architecture 100 is presented to show one example of an environment where an apparatus, method, and/or computer program product in accordance with the invention may be implemented. The network architecture 100 is presented only by way of example and is not intended to be limiting. Indeed, the apparatus, methods, and computer program products disclosed herein may be applicable to a wide variety of different network architectures in addition to the illustrated network architecture 100.

As shown, the network architecture 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems 106”). In general, client computers 102 may initiate communication sessions, whereas server computers 106 may wait for requests from the client computers 102. In certain embodiments, the computers 102 and/or servers 106 may connect to one or more internal or external direct-attached storage systems 112 such as arrays of hard disk drives or solid-state drives, tape libraries, tape drives, or the like. The computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. Connectivity through the network 108 may be provided by a switch, fabric, direct connection, or the like. Where the network 108 is a SAN, the servers 106 and storage systems 110 may communicate using a networking standard such as Fibre Channel (FC).

Error-reporting systems may be incorporated into any of the devices 102, 106, 110, 112 illustrated in FIG. 1 to reports errors that occur in the devices. Such error-reporting systems may enable programmers to quickly generate fixes or patches that will eliminate errors or reduce their frequency. The error-reporting systems may also allow system administrators to efficiently address or correct a problem, thereby reducing system downtime and potentially preventing more serious problems from occurring in the future. Thus, error-reporting systems may be used advantageously to reduce the number and frequency of errors that a hardware- and/or software-based system may encounter.

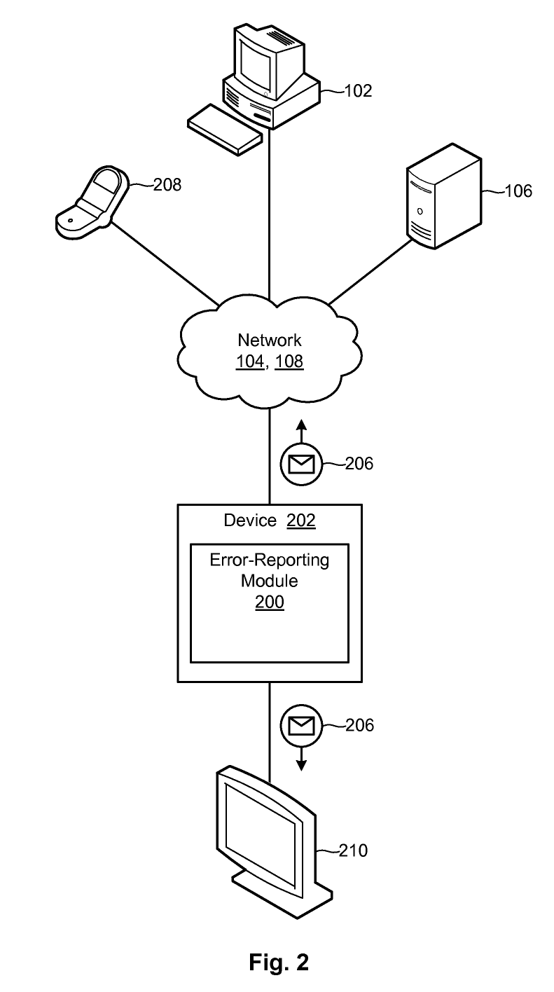

Referring to FIG. 2, in selected embodiments, an improved error-reporting system (hereinafter referred to as an “error-reporting module” 200) in accordance with the invention may be incorporated into any of the computing devices 102, 106, 110, 112 illustrated in FIG. 1 as well as other types of computing devices in other network architectures. Each computing device 102, 106, 110, 112 will be generally referred to hereinafter as a device 202.

As will be explained in more detail hereafter, when the error-reporting module 200 detects an error or group of errors occurring on the device 202 and certain other conditions are satisfied, the error-reporting module 200 sends a notification 206 to one or more devices, such as a mobile device 208, personal computer 102, workstation 102, or server 106. These notifications 206 may travel over one or more networks 104, 108. The notifications 206 may notify a system administrator or a software- or hardware-based system that an error has occurred so that corrective action may be taken. For example, a system administrator may receive the notification on a mobile device 208, such as a smart phone, personal digital assistant, laptop, or the like, so that he or she can take appropriate action.

Alternatively, the error-reporting module 200 may send the notification 206 to an output device, such as a computer monitor 210, which is directly connected to the device 202. As an example, if the error-reporting module 200 is running on a personal computer 202 and an error occurs on the computer 202, the error-reporting module 200 may send a notification 206 to a user of the personal computer 202 by way of the monitor 210. The user may receive the notification 206 and take appropriate action.

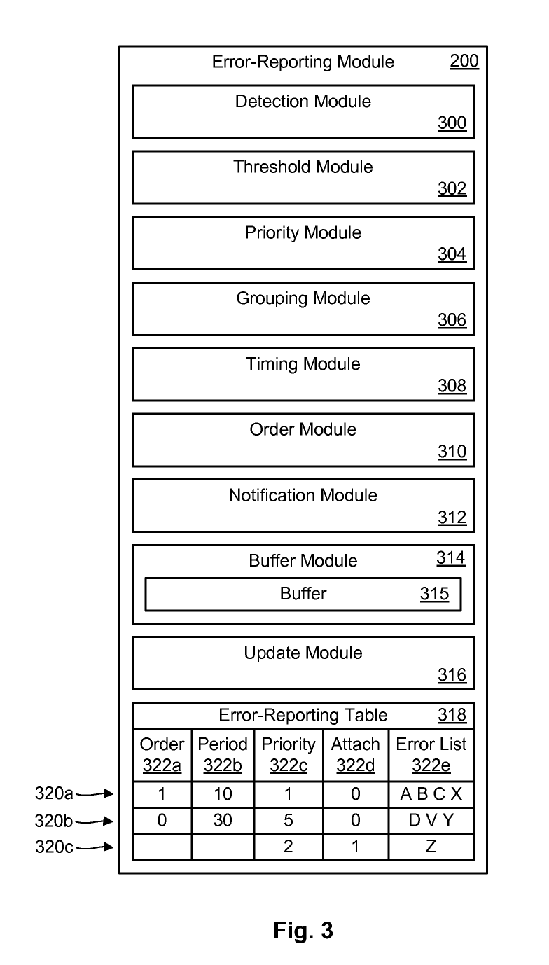

Referring to FIG. 3, to provide the functionality described above as well as provide additional functionality, the error-reporting module 200 may include one or more modules. These modules may be implemented in hardware, software or firmware executable on hardware, or a combination thereof. These modules are presented only by way of example and are not intended to be limiting. Indeed, alternative embodiments may include more or fewer modules than those illustrated. Furthermore, it should be recognized that, in some embodiments, the functionality of some modules may be broken into multiple modules or, conversely, the functionality of several modules may be combined into a single module or fewer modules. It should also be recognized that the modules are not necessarily implemented in the locations where they are illustrated. For example, functionality shown in a device 202 may actually be distributed across multiple devices. Thus, the location of the modules is presented only by way of example and is not intended to be limiting.

As shown, in certain embodiments, the error-reporting module 200 may include one or more of a detection module 300, a threshold module 302, a priority module 304, a grouping module 306, a timing module 308, an order module 310, a notification module 312, a buffer module 314, and an update module 316. One or more of the modules in the error-reporting module 200 may reference an error-reporting table 318, the purpose of which will be described in more detail hereafter.

A detection module 300 may detect whether an error has occurred on the device 202. If an error has occurred, a threshold module 302 may determine whether a notification threshold has been reached for a specified time window (e.g., such as a 24-hour window). For example, the threshold module 302 may limit the number of notifications 206 sent to a system administrator or other external system within a specified time window to some number (e.g., one to ten). If this threshold has been reached, the threshold module 302 may prevent sending additional notifications 206 until the next time window (e.g., 24-hour window) has begun. In this way, the threshold module 302 may keep a system administrator from being inundated with notifications 206.

A priority module 304 may determine the priority of an error or error group. This priority may be used to determine whether a notification 206 should be sent (assuming that a notification threshold has not been reached). In selected embodiments, a notification 206 will only be sent for an error having a greater priority than a previous error (or possibly a greater or equal priority) for which a notification 206 was already sent within the time window. In this way, a system administrator will not be notified of errors having a lesser or equal priority to errors for which he or she has already been notified. This may filter out lower priority (or equal priority) errors or error groups and keep the system administrator from being inundated with too many notifications 206. In certain embodiments, the threshold module 302 is omitted and the priority module 304 is responsible for regulating the number of notifications 206 that a system administrator receives. In other embodiments, the threshold module 302 and priority module 304 work together to regulate the number of notifications 206.

A grouping module 306 may be used to determine if an error belongs to an error group. An “error group” may be defined as a group of errors that together may (but do not necessarily) indicate a more serious failure or condition, and thus has a higher priority than the individual errors by themselves. An error group may be said to “occur” when all the errors in the error group occur within a specified time and/or in a specified order. In certain cases, error groups may be useful to determine the root cause of problems as opposed to just the symptoms. For example, a device failure or crash may generate several (e.g., ten to twenty) errors. Each of these errors by themselves may not be considered serious or indicate the root cause. Thus, the errors by themselves may not warrant notifying a system administrator. However, the combination of errors may indicate a more serious condition, in this example a device failure or crash. In such a case, the combination of errors may be assigned a higher priority than the errors by themselves. Such a combination may warrant sending a notification 206 to a system administrator.

A timing module 308 may be used to determine the timing of a group of errors. For example, the timing module 308 may be used to determine whether all errors in an error group occur within a specified amount of time. Using the previous example, the timing module 308 may be used to determine that a device crash or failure has occurred if all errors associated with the crash or failure occur within a specified amount of time. This may prevent errors that are distributed over a relatively longer period of time from being interpreted to indicate a more serious error or condition.

An order module 308 may be used to determine whether errors occur in a particular order. For example, the order module 308 may determine that an error group only occurs if the errors contained therein occur in a specified order. Using the example presented above, a device crash or failure may be determined to occur only if all errors associated with the crash or failure occur in a specified order. This may prevent errors that occur randomly or out of order from being indicative of a more serious error or condition.

A notification module 312 may be configured to send a notification 206 to a system administrator or other device when various conditions are satisfied. These conditions may include, for example, whether the notification threshold is reached, whether the priority of an error or error group is sufficient to warrant sending a notification, whether all errors in an error group are present to warrant sending a notification, whether the errors in an error group occur within a specified amount of time, whether the errors in an error group occur in a specified order, or the like.

In selected embodiments, the error-reporting module 200 includes a buffer module 314. The buffer module 314 may record errors and error groups that did not warrant sending a notification 206 at the time they occurred. These errors, for example, may include those that did not have a high enough priority, belonged to error groups that did not have a high enough priority, or the like. When the next notification 206 is sent (such as when an error or error group having a high enough priority occurs), the errors or error groups that are stored in the buffer 315 may be attached to the notification 206. This allows a system administrator to review the errors or error groups even if they were not important enough to send a notification 206 at the time they occurred.

As previously mentioned, the modules in the error-reporting module 200 (including but not limited to the priority module 304, the grouping module 306, the timing module 308, and the order module 310) may reference an error-reporting table 318. This error-reporting table 318 may store information about each error and error group, the priority of each error and error group, and whether an error or error group should be stored in the buffer 315 for attachment to a later notification 206. Among other information, the error-reporting table 318 may also store the order, if any, in which errors need to occur for each error group, and the time period in which errors need to occur for each error group.

For example, as shown in FIG. 3, an error group 320a (represented by the first row in the error-reporting table 318) includes errors “A,” “B,” “C,” and “X” as indicated in the error list column 322e. For the error group 320a to occur, the individual errors need to occur in the listed order as indicated by the “1” in the order column 322a. The “10” in the period column 322b indicates that the errors need to occur within a period of ten minutes (or other unit of time) for the error group 320a to occur. The “1” in the priority column 322c indicates that the error group 320a has a priority of one (with one being the highest priority in this example). The “0” in the attach column 322d indicates that the error group should not be attached to higher priority notifications 206. In such a case, the error group record may be discarded rather than stored in the buffer 315 for later attachment and transmission.

Similarly, a second error group 320b includes the errors “D,” “V,” and “Y” as indicated in the error list column 322e. The errors may occur in any order as indicated by the “0” in the order column 322a. The “30” in the period column 322b indicates that the errors need to occur in a period of thirty minutes for the error group 320b to occur. The “5” in the priority column 322c indicates that the error group 320b has a priority of five. The “0” in the attach column 322d indicates that the error group information should not be attached to higher priority notifications 206. Thus, there is no need to record it in the buffer 315.

Finally, an error 320c includes the single error “Z” as indicated in the error list column 322e. The order column 322a is left empty to indicate that no order is specified (since only a single error is present). The period column 322b is also left empty to indicate that no time period is specified (since only a single error is present). The “2” in the priority column 322c indicates that the error 320c has a priority of two. The “1” in the attach column 322d indicates that the error should be attached to higher priority notifications 206. Thus, the error 320c may be stored in the buffer 315 for later attachment and transmission.

The error-reporting table 318 is presented only by way of example and is not intended to be limiting. Indeed, different types of information may be deleted from or added to the error-reporting table 318 as needed. Similarly, the format and units shown in the error-reporting table 318 may be modified as needed. In selected embodiments, an update module 316 may be provided to update the error-reporting table 318. This may occur in an automated fashion (e.g., by automatic downloads, etc.) or in a manual fashion (e.g., downloads in response to user input, etc.) For example, new error groups 320 may be added to the error-reporting table 318 as relationships between errors are discovered. Similarly, the order 322a, period 322b, and priority 322c of certain errors or error groups may be modified as additional knowledge is acquired about the errors or error groups. In other cases, errors may be added to or deleted from an error group's error list 322e.

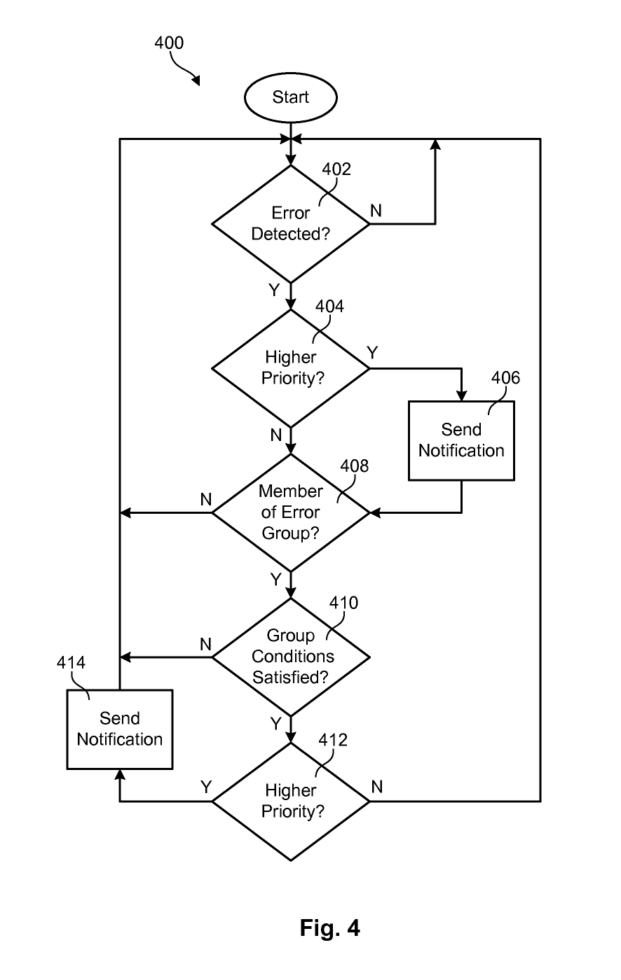

Referring to FIG. 4, one embodiment of a method 400 for reporting errors is illustrated. As shown, the method 400 initially determines 402 whether an error has occurred in a device 202. If an error is detected, the method 400 determines 404 whether the error has a higher priority than errors or error groups already reported in previous notifications 206 during the time window (e.g., the 24-hour window). If the error has a higher priority, the method 400 sends 406 a notification 206 containing information about the error. If an error is the first error in a time window, the notification 206 may be sent 406 for the error regardless of its priority. If, on the other hand, the error has a lower or equal priority than a previous error or error group that occurred during the time window, the method 400 does not send a notification 206.

Next, the method 400 determines 408 whether the error is a member of one or more error groups. If the error belongs to one or more error groups, the method 400 determines 410 whether the conditions for the one or more error groups are satisfied. This may include, for example, determining whether all errors in an error group have occurred, whether all errors in an error group have occurred during a specified time period (if any), whether the errors in an error group have occurred in a specified order (if any), or the like. The error-reporting table 318 may be used to make these determinations. If the conditions for one or more error groups have been satisfied, the method 400 determines 412 whether the error groups have higher priorities than errors or error groups associated with previous notifications 206 during the time window. If an error group has a higher priority, the method 400 sends 414 a notification 206 containing information about the error group. If, on the other hand, the error group has a lower or equal priority, the method 400 does not send a notification 206.

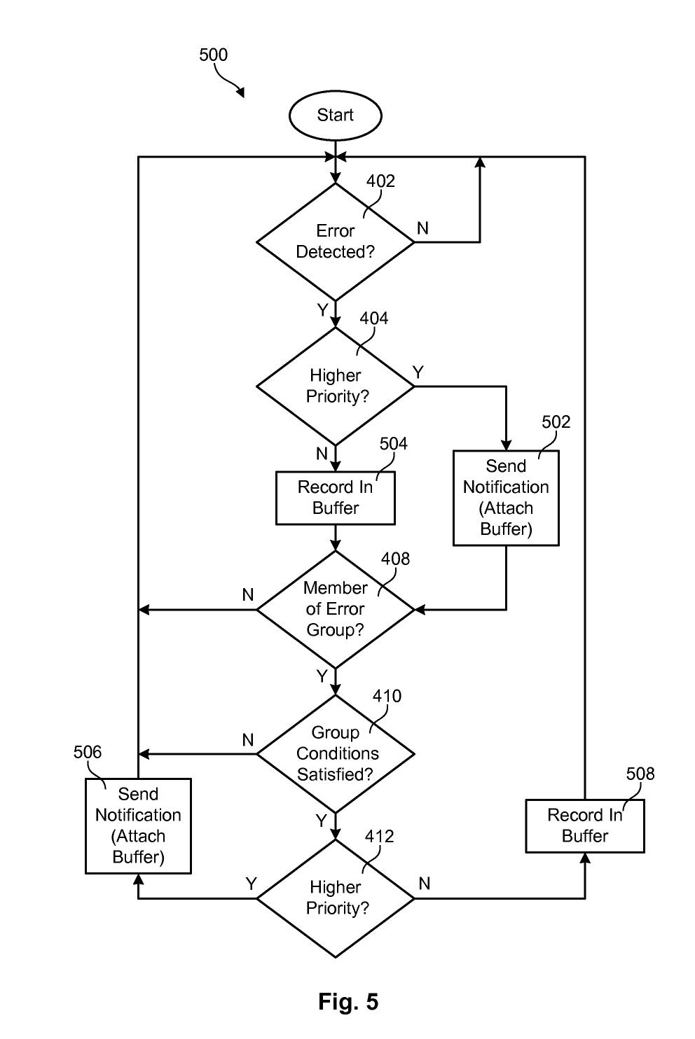

Referring to FIG. 5, an alternative embodiment of a method 500 for reporting errors is illustrated. Like the previous method 400, the method 500 initially determines 402 whether an error has occurred in a device 202. The method 500 then determines 404 whether the error has a higher priority than errors or error groups already reported in previous notifications 206 during the specified time window. If the error has a higher priority, the method 500 sends 502 a notification 206 containing the error. In doing so, the method 500 attaches 502 any error or error groups that are recorded in the buffer 315. As previously explained, the buffer 315 stores errors or error groups that did not have a high enough priority to warrant sending a notification 206 at the time they occurred. If the error has a lower or equal priority to an error or error group sent in a previous notification 206 during the time window, the method 500 records 504 the error in the buffer 315 so that it can be attached to a notification 206 at a later time.

Next, the method 500 determines 408 whether the error belongs to one or more error groups. If the error belongs to one or more error groups, the method 500 determines 410 whether the conditions for the one or more error groups have been satisfied. If satisfied, the method 500 determines 412 whether the one or more error groups have higher priorities than errors or error groups already sent in previous notifications 206 during the time window. If an error group has a higher priority, the method 500 sends 506 a notification 206 containing the error group. Upon doing so, the method attaches 506 any errors or error groups that are recorded in the buffer 315. If the error group has a lower or equal priority to an error or error group sent in a previous notification 206, the method 500 records 508 the error group in the buffer 315 so that it may be attached to a notification 206 at a later time.

The methods 400, 500 illustrated in FIGS. 4 and 5 may be modified in various respects without departing from the spirit of the invention. For example, referring to FIG. 4, if a notification 206 is initially sent at step 406, the method 400 may return to step 402 (which waits for the next error to occur) instead of proceeding to determine 408 whether the error belongs to an error group and possibly sending 414 another notification. This will prevent multiple notifications 206 from being sent for the same error (once for the error individually and again for the error as part of an error group). Similarly, if a notification 206 is sent for an error as part of an error group, the method 400 may refrain from sending a notification 206 for the error individually. These modifications may reduce the number of notifications 206 sent to an administrator. Other modifications are also possible and within the scope of the invention. The method 500 of FIG. 5 may be modified in a similar manner.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for reporting errors, the method comprising:
detecting an error;
determining whether the error belongs to an error group comprising a plurality of errors;
determining whether all errors in the error group have occurred within a specified time period; and
automatically sending a notification in the event all errors in the error group have occurred within the specified time period.

2. The method of claim 1, further comprising determining a priority for the error group.

3. The method of claim 2, wherein automatically sending the notification comprises sending the notification if the priority is sufficient.

4. The method of claim 1, further comprising specifying an order for the errors in the error group.

5. The method of claim 4, wherein automatically sending the notification comprises sending the notification if all errors in the error group occur in the specified order.

6. The method of claim 1, further comprising, prior to automatically sending the notification, determining whether a notification threshold has been reached.

7. The method of claim 6, wherein automatically sending the notification comprises sending the notification if the notification threshold has not been reached.

8. A computer program product for reporting errors, the computer program product comprising a computer-usable storage medium having computer-usable program code embodied therein, the computer-usable program code comprising:
computer-usable program code to detect an error;
computer-usable program code to determine whether the error belongs to an error group comprising a plurality of errors;
computer-usable program code to determine whether all errors in the error group have occurred within a specified time period; and
computer-usable program code to automatically send a notification in the event all errors in the error group have occurred within the specified time period.

9. The computer program product of claim 8, further comprising computer-usable program code to determine a priority for the error group.

10. The computer program product of claim 9, wherein automatically sending the notification comprises sending the notification if the priority is sufficient.

11. The computer program product of claim 8, further comprising computer-usable program code to specify an order for the errors in the error group.

12. The computer program product of claim 11, wherein automatically sending the notification comprises sending the notification if the errors occur in the specified order.

13. The computer program product of claim 8, further comprising computer-usable program code to, prior to automatically sending the notification, determine whether a notification threshold has been reached.

14. The computer program product of claim 13, wherein automatically sending the notification comprises sending the notification if the notification threshold has not been reached.

15. The computer program product of claim 8, wherein automatically sending the notification comprises attaching the error group to a notification associated with another error or error group having sufficient priority.

16. An apparatus for reporting errors occurring in a device, the apparatus comprising:
a detection module to detect an error;
a grouping module to determine whether the error belongs to an error group comprising a plurality of errors;
a timing module to determine whether all errors in the error group have occurred within a specified time period; and
a notification module to automatically send a notification in the event all errors in the error group have occurred within the specified time period.

17. The apparatus of claim 16, further comprising a priority module to determine a priority for the error group.

18. The apparatus of claim 17, wherein the notification module is configured to automatically send the notification if the priority is sufficient.

19. The apparatus of claim 16, further comprising an order module to specify an order for the errors in the error group.

20. The apparatus of claim 19, wherein the notification module is configured to send the notification if the errors occur in the specified order.
